(19) United States
(12) Patent Application Publication
(10) Pub. No.: US 2016/0205643 A1
(43) Pub. Date: Jul. 14, 2016

(54) WIRELESS COMMUNICATION NETWORK REPEATER

(71) Applicant: GSInstruments Co.,Ltd., Incheon (KR)

(72) Inventor: Jae Mok Ko, Incheon (KR)

(21) Appl. No.: 14/594,179

(22) Filed: Jan. 12, 2015

(51) Int. Cl. H04W 56/00; H04L 27/12; H04B 17/40; H04B 7/155

(52) U.S. Cl. CPC H04W 56/001; H04B 7/15507; H04L 27/122; H04B 17/40

(57) ABSTRACT

Disclosed herein is a wireless communication network repeater. The wireless communication network repeater includes a donor antenna unit configured to receive an RF signal from a base station or a repeater, convert the RF signal into an IF signal, and generate a compensation signal for compensating for the intensity of a signal according to the transmission length of a cable, a service antenna unit configured to receive an RF signal from a terminal, convert the received RF signal into an IF signal, receive the compensation signal, and compensate for the intensity of a signal according to the transmission length of the cable; and the cable configured to send signals between the donor antenna unit and the service antenna unit and send at least any one of the IF signal and the compensation signal.

### CROSS REFERENCE TO RELATED APPLICATION

None.

### BACKGROUND OF THE INVENTION

1. Technical Field

The present invention relates to a wireless communication network repeater and, more particularly, to a wireless communication network repeater which is capable of solving a communication shadow area in a closed space within a building by connecting a donor antenna unit and a service antenna unit using a coaxial cable in order to extend the range of a communication service area.

2. Description of the Related Art

In general, a wireless communication network repeater is a device used in a communication shadow area in which wireless communication signals are difficult to be received, such as the inside of a building or a closed space. A user may use wireless communication in communication shadow areas more smoothly through such a device.

Conventional wireless communication network repeaters are disclosed in US 2004/0097189, US 2005/0176368, and US 2006/0205344.

In the conventional wireless communication network repeaters, however, synchronization between a donor antenna unit and a service antenna unit need to be matched because the donor antenna unit and the service antenna unit are connected using a coaxial cable. Furthermore, there is a need to control the intensity of a signal because the length of the coaxial cable may be different depending on an installation place.

### SUMMARY OF THE INVENTION

Accordingly, the present invention has been made keeping in mind the above problems occurring in the prior art, and an object of the present invention is to provide a wireless communication network repeater capable of supplying a wireless communication signal having quality of high reliability to a communication shadow area by synchronizing the synchronization signals of a donor antenna unit and a service antenna unit.

In accordance with an aspect of the present invention, there is provided a wireless communication network repeater, including a donor antenna configured to receive an external RF signal, a down-converter unit configured to convert the RF signal into an IF signal, an up-converter unit configured to receive an external IF signal and convert the received IF signal into an RF signal, a signal generation unit configured to generate a reference synchronization signal or receive an external reference synchronization signal, generate a local signal based on the reference synchronization signal, and output the local signal to the down-converter unit and the up-converter unit, and a compensation signal generation unit configured to generate a compensation signal for compensating for the intensity of a signal according to the transmission length of a cable.

Furthermore, the donor antenna unit may further include a signal size control unit configured to control the size of the RF signal or IF signal depending on the intensity of the signal.

Furthermore, the signal size control unit is configured to include an attenuator.

Furthermore, the RF signal received from the donor antenna is amplified by a low noise amplifier and transmitted to the down-converter unit. The RF signal converted by the up-converter unit is amplified by an RF amplifier and transmitted.

Furthermore, the cable may include a coaxial cable. DC power is supplied by a service antenna unit through the coaxial cable.

Furthermore, the donor antenna includes an omni antenna. The donor antenna may be embedded in the donor antenna unit or provided outside the donor antenna unit in order to solve a service shadow area.

Furthermore, the donor antenna unit may further include a bandpass filter block. The bandpass filter block is configured to include a first bandpass filter block configured to include a splitter and a combiner and to form at least any one of filter bands of 5 MHz, 10 MHz, and 15 MHz, a second bandpass filter block configured to include a bandpass filter of 5 MHz, and a third bandpass filter block configured to include a bandpass filter of 10 MHz.

Furthermore, the compensation signal generation unit generates an FSK signal. The FSK signal is transmitted to a service antenna unit through the cable.

In accordance with another aspect of the present invention, there is provided a wireless communication network repeater, including a service antenna configured to receive an external RF signal, a down-converter unit configured to convert the RF signal into an IF signal, an up-converter unit configured to receive an external IF signal and convert the received IF signal into an RF signal, a signal generation unit configured to generate a reference synchronization signal or receive an external reference synchronization signal, generate a local signal based on the reference synchronization signal, and output the local signal to the down-converter unit and the up-converter unit, and a signal intensity compensation unit configured to receive an external compensation signal and compensate for the intensity of a signal according to the transmission length of a cable.

Furthermore, the RF signal received from the service antenna is amplified by a low noise amplifier and transmitted to the down-converter unit. The RF signal converted by the up-converter unit is amplified by an RF amplifier and transmitted.

Furthermore, the cable may include a coaxial cable. DC power is supplied to a donor antenna unit through the coaxial cable.

Furthermore, the service antenna includes an omni antenna. The service antenna may be embedded in the service antenna unit or provided outside the service antenna unit in order to solve a service shadow area.

Furthermore, a plurality of the service antennas may be provided if the service antenna is provided outside the service antenna unit.

Furthermore, the service antenna unit may further include a bandpass filter block. The bandpass filter block is configured to include a first bandpass filter block configured to include a splitter and a combiner and to form at least any one of filter bands of 5 MHz, 10 MHz, and 15 MHz, a second bandpass filter block configured to include a bandpass filter of 5 MHz, and a third bandpass filter block configured to include a bandpass filter of 10 MHz.

Furthermore, the compensation signal includes an FSK signal transmitted by a donor antenna unit. The signal intensity compensation unit calculates an RSSI value using the FSK signal and compensates for the intensity of a signal by controlling an attenuator based on the RSSI value.

Furthermore, the service antenna unit may further include an FSK signal generation unit configured to generate an FSK signal and send the FSK signal to a donor antenna unit through the cable.

In accordance with yet another aspect of the present invention, there is provided a wireless communication network repeater, including a donor antenna unit configured to receive an RF signal from a base station or a repeater, convert the RF signal into an IF signal, and generate a compensation signal for compensating for the intensity of a signal according to the transmission length of a cable, a service antenna unit configured to receive an RF signal from a terminal, convert the received RF signal into an IF signal, receive the compensation signal, and compensate for the intensity of a signal according to the transmission length of the cable, and the cable configured to send signals between the donor antenna unit and the service antenna unit and send at least any one of the IF signal and the compensation signal.

Furthermore, at least any one of the donor antenna unit and the service antenna unit generates a reference synchronization signal and sends the reference synchronization signal to a counterpart so that the donor antenna unit and the service antenna unit are synchronized with each other. The cable includes a coaxial cable. The coaxial cable transfers DC voltage generated by the service antenna unit to the donor antenna unit and transfers the IF signal, the compensation signal, the reference synchronization signal, and the DC voltage.

Furthermore, the service antenna unit generates an FSK signal and sends the FSK signal to the donor antenna unit. The donor antenna unit calculates an RSSI value using the FSK signal and determines whether the cable is normal or not.

Furthermore, the compensation signal includes an FSK signal. The service antenna unit calculates an RSSI value using the FSK signal and controls at least any one of a downlink attenuator and an uplink attenuator based on the RSSI value.

### BRIEF DESCRIPTION OF THE DRAWINGS

The following drawings attached to this specification illustrate exemplary embodiments of the present invention and function to facilitate further understanding of the technical spirit of the present invention along with the detailed description of the invention. Accordingly, the present invention should not be construed as being limited to only matters illustrated in the drawings.

FIG. 1 is a block diagram schematically illustrating an overall configuration of a wireless communication network repeater in accordance with an embodiment of the present invention;

FIG. 2 is a block diagram illustrating the internal structure of the wireless communication network repeater of FIG. 1;

FIG. 3 is a diagram illustrating the frequency bands of a cable in accordance with an embodiment of the present invention;

FIG. 4 is an example in which the band selection filter of the wireless communication network repeater in accordance with an embodiment of the present invention is used and is a block diagram illustrating an overall configuration of the band selection filter of the wireless communication network repeater including four blocks;

FIG. 5 is a block diagram illustrating the configuration of the band selection filter of a donor antenna unit in the band selection filter of FIG. 4;

FIG. 6 is a diagram illustrating a range of the frequency band that has passed through a band 1 in the band selection filter of the wireless communication network repeater of FIG. 5;

FIG. 7 is a first embodiment of the wireless communication network repeater in accordance with an embodiment of the present invention and is a block diagram illustrating a wireless communication network repeater including omni antennas;

FIG. 8 is a second embodiment of the wireless communication network repeater in accordance with an embodiment of the present invention and is a diagram illustrating that a wireless communication signal is supplied to two rooms spaced apart from each other using the wireless communication network repeater;

FIG. 9 is a third embodiment of the wireless communication network repeater in accordance with an embodiment of the present invention and is a diagram illustrating that a wireless communication signal is supplied to the inside of a room including an obstacle using the wireless communication network repeater; and

FIG. 10 is a fourth embodiment of wireless communication network repeater in accordance with an embodiment of the present invention and is a diagram illustrating that a wireless communication signal is supplied using an additional service antenna unit.

### DETAILED DESCRIPTION

An embodiment of the present invention relates to supplying a communication shadow area, such as the inside of a building, with a wireless communication signal having quality of high reliability. Hereinafter, some exemplary embodiments of the present invention are described below with reference to the accompanying drawings. Furthermore, it should be noted that the embodiments to be described below do not unreasonably limit the contents of the present invention written in the claims and all the elements described in the embodiments may not be considered to be essential as means for solving the present invention.

(Configuration of Wireless Communication Network Repeater)

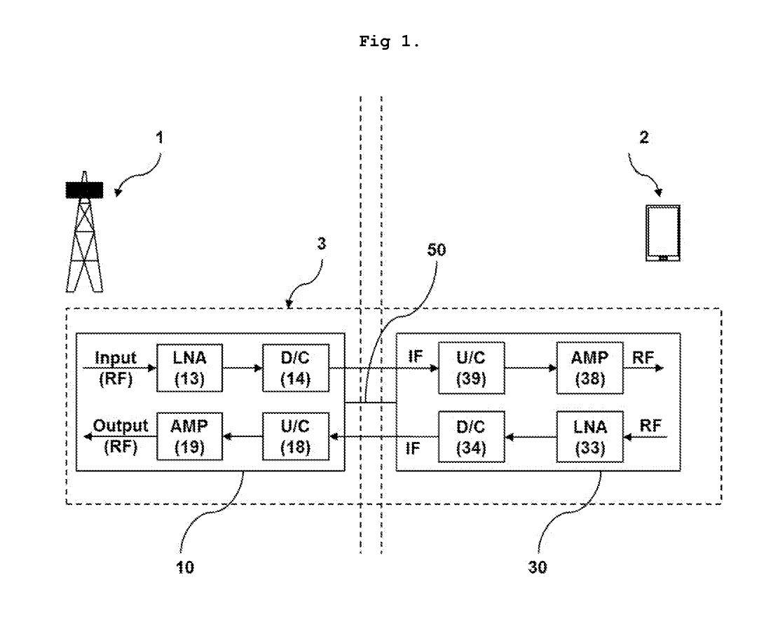

FIG. 1 is a block diagram schematically illustrating an overall configuration of a wireless communication network repeater in accordance with an embodiment of the present invention.

As illustrated in FIG. 1, the wireless communication network repeater 3 is configured to include a donor antenna unit (DAU) 10, a service antenna unit (SAU) 30, and a coaxial cable 50 configured to connect the two antenna units. The donor antenna unit 10 exchanges RF signals with a base station 1, and the service antenna unit 30 exchanges RF signals with a wireless communication device 2. The coaxial cable is described below as an example, but all types of wired cables through which signals are able to be exchanged between the donor antenna unit 10 and the service antenna unit 30 may be included in the category of the present invention.

A flow (i.e., downlink) of a signal that is transmitted from the base station 1 to the wireless communication device 2 via the wireless communication network repeater 3 is described below with reference to FIG. 1. In this case, FIG. 1 illustrates schematic configurations of the donor antenna unit 10 and the service antenna unit 30 in order to describe a method of sending an RF signal between the base station 1 and the wireless communication device 2. One or more elements may be added to the configurations, if necessary.

First, when the base station 1 sends an RF signal, the donor antenna unit 10 of the wireless communication network repeater 3 receives the RF signal transmitted by the base station 1. The received RF signal is amplified by the first low noise amplifier (LNA) 13 of the donor antenna unit 10. The RF signal that has passed through the first low noise amplifier 13 is transmitted to a first downlink converter (D/C) 14. The first downlink converter 14 performs down-conversion on the RF signal so that the RF signal is converted into an IF signal. Furthermore, the IF signal is transmitted to the service antenna unit 30 through the coaxial cable 50. The second uplink converter (U/C) 39 of the service antenna unit performs up-conversion on the IF signal so that the IF signal is converted into an RF signal again. A second amplifier 38 amplifies the up-converted RF signal, and the amplified RF signal is transmitted from the service antenna unit 30 to the wireless communication device 2.

Furthermore, a flow (i.e., uplink) of a signal that is transmitted from the wireless communication device 2 to the base station 1 via the wireless communication network repeater 3 is described below with reference to FIG. 1. First, when the wireless communication device 2 sends an RF signal, the service antenna unit 30 of the wireless communication network repeater 3 receives the RF signal transmitted by the wireless communication device 2. The received RF signal is amplified by the second low noise amplifier 33 of the service antenna unit 30. The RF signal that has passed through the second low noise amplifier 33 is converted into an IF signal through a second downlink converter 34. The converted IF signal is transmitted to the donor antenna unit 10 through the coaxial cable 50. The transmitted IF signal is converted into an RF signal through the first uplink converter 18 of the donor antenna unit 10 and then amplified by a first amplifier 19. The amplified RF signal is transmitted from the donor antenna unit 10 to the base station 1.

(Configuration of Donor Antenna Unit and Service Antenna Unit)

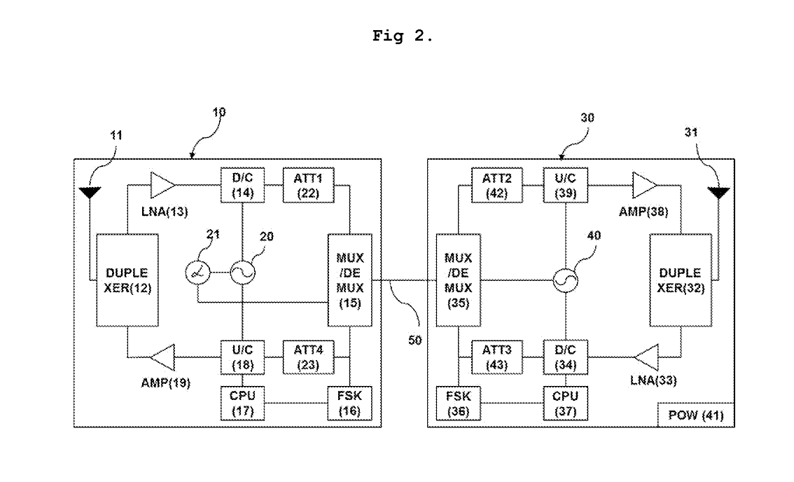

FIG. 2 is a block diagram illustrating the internal structures of the donor antenna unit 10 and the service antenna unit 30 illustrated in FIG. 1.

First, a downlink flow and the configuration of the donor antenna unit 10 are described below. As illustrated in FIG. 2, the donor antenna unit 10 basically includes an embedded donor antenna 11, a first duplexer 12, a first low noise amplifier 13, a first downlink converter 14, a first attenuator 22, a first muxer 15, a fourth attenuator 23, a first uplink converter 18, a first amplifier 19, a first local oscillator 20, a reference oscillator 21, a first FSK modem 16, and a first CPU 17. In this case, the first muxer 15 is configured to include a demuxer and a muxer.

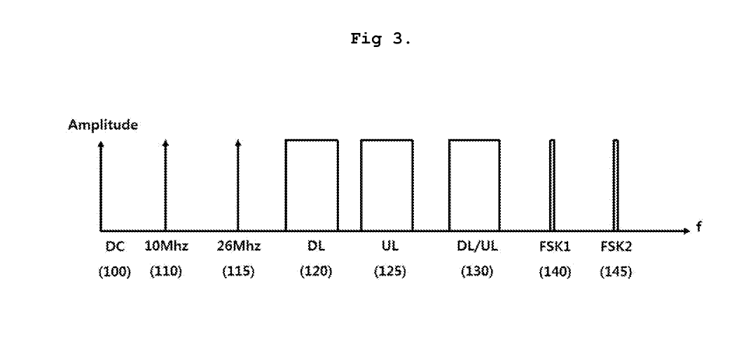

The donor antenna 11 functions to receive an RF signal from the base station 1 or to send an RF signal to the base station 1. The donor antenna 11 may be installed inside or outside the donor antenna unit 10. If the donor antenna 11 is installed outside the donor antenna unit 10, the intensity of an RF signal received from the base station may be weak. For example, the donor antenna 11 may be implemented using an omni antenna. The first duplexer 12 separates a received RF signal and a transmitted RF signal and selects a frequency band. The first low noise amplifier 13 amplifies a received RF signal. The first downlink converter 14 converts an RF signal into an IF signal using a signal received from the first local oscillator 20. The first local oscillator 20 receives a reference synchronization signal from the reference oscillator 21 and sends a local signal to the first downlink converter 14, the first uplink converter 18, and the first muxer 15. In this case, as illustrated in FIG. 3, the reference oscillator 21 may generate a signal having a frequency of 10 MHz in the case of an FDD method and a signal having a frequency of 26 MHz in the case of a TDD method and provides the generated signal to the first local oscillator 20. In this case, a frequency, such as 10 MHz or 26 MHz, may be changed, if necessary. Furthermore, in an embodiment of the present invention, synchronization between the donor antenna unit 10 and the service antenna unit 30 is matched by providing such a reference synchronization signal (10 MHz or 26 MHz) to the service antenna unit 30 through the coaxial cable 50. Furthermore, a converted IF signal is transmitted to the first muxer 15.

In order to optimize a signal according to the length of a coaxial cable, the first FSK modem 16 generates a first FSK signal and sends the first FSK signal to the first muxer 15. A method of optimizing a signal according to the length of a coaxial cable is described later. The first muxer sends a signal, including the received first FSK signal, the IF signal, and the reference synchronization signal, to the service antenna unit 30 through a coaxial cable 50.

The configuration of the service antenna unit 30 in downlink is described below. The service antenna unit 30 includes an embedded service antenna 31, a second duplexer 32, a second low noise amplifier 33, a second downlink converter 34, a second muxer 35, a second uplink converter 39, a second amplifier 38, a second local oscillator 40, a second attenuator 42, a third attenuator 43, a second FSK modem 36, a second CPU 37, and a power source unit 41. In this case, the second muxer 35 is configured to include a demuxer and a muxer.

The second muxer 35 receives signals from the donor antenna unit 10 through the coaxial cable 50 and separates the signals. A first FSK signal of the separated signals is transmitted to the second CPU 37 in which the value of the received signal strength indicator (RSSI) of the first FSK signal is calculated. The service antenna unit 30 generates a second FSK signal using the second FSK modem 36 and sends the second FSK signal to the donor antenna unit 10. In this case, the service antenna unit 30 may generate various modulation signals, such as an amplitude shift keying (ASK) signal and a phase shift keying (PSK) signal, in addition to an FSK signal, if necessary. In this case, the aforementioned modem may be implemented using various modulation signal generators, such as an ASK modem and a PSK modem.

The second muxer 35 sends an IF signal of the separated signals to the first attenuator 42. The first attenuator 42 sends the IF signal to the second uplink converter 39. Furthermore, the second muxer 35 sends a reference synchronization signal of the separated signals to the second local oscillator 40. The second local oscillator generates a local signal using the reference synchronization signal and sends the generated local signal to the second uplink converter 39 and the second downlink converter 34. Accordingly, in an embodiment of the present invention, the reference synchronization signal (10 MHz or 26 MHz) generated by the donor antenna unit 10 is transmitted to the service antenna unit 30 so that the reference synchronization signal of the donor antenna unit 10 is synchronized with that of the service antenna unit 30. As a result, precise synchronization can be performed.

The second uplink converter 39 receives the IF signal from the first attenuator 42 and the reference synchronization signal from the second local oscillator 40, converts the received IF signal into an RF signal again, and sends the RF signal to the second amplifier 38. The second amplifier 38 amplifies the received RF signal and sends the amplified RF signal to the second duplexer 32. Furthermore, the second duplexer 32 transfers the amplified RF signal to the service antenna 31. The service antenna 31 sends the received RF signal to the wireless communication device 2. In this case, the service antenna 31 may be implemented using an omni antenna and installed inside or outside the service antenna unit 30. If the service antenna 31 is installed outside the service antenna unit 30, a shadow area problem in a communication service area may be solved because an obstacle is present within a building. Such an embodiment is described later.

The configuration of the service antenna unit 30 in uplink is described below.

First, the service antenna 31 receives an RF signal from the wireless communication device 2 and sends the RF signal to the second duplexer 32. The second duplexer 32 separates the received RF signal and a transmitted RF signal and selects a frequency band. The second low noise amplifier 33 amplifies the RF signal received from the second duplexer and sends the amplified RF signal to the second downlink converter 34. In this case, the second downlink converter 34 converts the RF signal into an IF signal using a local signal received from the second local oscillator 40. The converted IF signal is transmitted to the donor antenna unit 10 through the second attenuator 43 and the second muxer 35.

In an embodiment of the present invention, a power source provided by the power source unit 41 of the service antenna unit 30 is used in the donor antenna unit 10 through the coaxial cable 50. Accordingly, installation can be simplified compared to a conventional method of supplying power sources to the donor antenna unit 10 and the service antenna unit 30, respectively. The power source unit 41 of the service antenna unit 30 receives a power source from an electrical outlet provided in an indoor building and configured to supply prevailing voltage, supplies the received power source to various elements of the service antenna unit 30, and also supplies the power source to the donor antenna unit 10 through the coaxial cable 50. The power source unit 41 may receive prevailing voltage from an electrical outlet and convert the received prevailing voltage into DC voltage or may receive converted DC voltage through a DC converter (not illustrated) provided between the service antenna unit 30 and an electrical outlet.

Furthermore, the second muxer 35 generates a signal, including the second FSK signal, the DC voltage, and the converted IF signal received from the wireless communication device 2, and sends the generated signal to the first muxer 15 of the donor antenna unit 10 through the coaxial cable 50. The transmitted signal is separated into the second FSK signal, the DC voltage, and the IF signal through the first muxer 15. In this case, the DC voltage is supplied to the elements of the donor antenna unit 10, and the second FSK signal is transmitted to the first CPU 17. Furthermore, the first uplink converter 18 receives the IF signal, converts the received IF signal into an RF signal using a local signal received from the first local oscillator 20, and sends the converted RF signal to the first amplifier 19. The first amplifier 19 amplifies the received RF signal and sends the amplified RF signal to the first duplexer 12. The first duplexer 12 transfers the received RF signal to the donor antenna 11. The transferred RF signal is transmitted to the base station 1 through the donor antenna 11.

The first attenuator 22 and fourth attenuator 23 of the donor antenna unit 10 are for automatic gain control (AGC) for keeping a cell balance between the wireless communication network repeater 3 and the base station 1 of the present invention.

In the aforementioned embodiment, the reference oscillator 21 has been illustrated as being placed in the donor antenna unit 10. In another embodiment, the reference oscillator 21 may be included in the service antenna unit 30. In this case, a reference synchronization signal generated by the reference oscillator 21 is transmitted to the second local oscillator 40 of the service antenna unit 30 and simultaneously to the first local oscillator 20 of the donor antenna unit 10 through the coaxial cable 50, so the reference synchronization signal may be used to match synchronization between the second local oscillator 40 and the first local oscillator 20.

(Frequency Band of Coaxial Cable)

FIG. 3 is a diagram illustrating the frequencies of respective bands transmitted through the coaxial cable. Frequencies transmitted through the coaxial cable 50 are described below with reference to FIG. 3. The service antenna unit 30 sends DC voltage 100 to the donor antenna unit 10. Furthermore, a signal of 26 MHz 115 may be transmitted as the reference synchronization signal in the case of a TDD method, and a signal of 10 MHz 110 may be transmitted as the reference synchronization signal in the case of an FDD method. In the case of the FDD method, a downlink frequency band 120 and an uplink frequency band 125 may occupy respective specific bandwidths, as illustrated in FIG. 3. A bandwidth and a frequency may be differently set in each communication operator or each country. In the case of the TDD method, a frequency band 130 is the same as that illustrated in FIG. 3 because a frequency is the same in downlink and uplink. Likewise, a frequency and a bandwidth may be differently set in each communication operator or each country. The frequency band of a first FSK signal 140 and a second FSK signal 145 transmitted in order to calculate an RSSI value occupies a bandwidth of 25 KHz, as illustrated in FIG. 3. The first FSK signal 140 illustrated in FIG. 3 is a signal transmitted in order to calculate an RSSI value (i.e., an RSSI 1 value or an RSSI 2 value) in the FDD method. The second FSK signal 145 is a signal transmitted in order to calculate an RSSI value (i.e., the RSSI 1 value or the RSSI 2 value) in the TDD method. In this case, each of the frequency bands (i.e., spectra) illustrated in FIG. 3 may have a different frequency, if necessary, and thus may be different from each of the frequency bands illustrated in FIG. 3.

(Signal Optimization According to Length of Coaxial Cable)

The coaxial cable 50 may be installed up to about 50 m (i.e., 164 ft)˜160 m (i.e., 525 ft) depending on an installation place. Accordingly, the intensity of a signal transmitted from the donor antenna unit 10 to the service antenna unit 30 or from the service antenna unit 30 to the donor antenna unit 10 needs to be controlled depending on the length of a cable. In order to control the intensity of a signal, an RSSI value is used as follows. First, the FSK modem 16 of the donor antenna unit 10 generates a first FSK signal and sends the first FSK signal to the service antenna unit 30 through the first muxer 15. The second muxer 35 of the service antenna unit 30 sends the first FSK signal to the second CPU 37. The second CPU 37 calculates the value of a first RSSI 1. Furthermore, the second FSK modem 36 of the service antenna unit 30 generates a second FSK signal and sends the second FSK signal to the donor antenna unit 10 through the second muxer 35. In this case, the RSSI 1 value calculated by the second CPU 37 may also be transmitted to the donor antenna unit 10. The first muxer 15 of the donor antenna unit 10 sends the received second FSK signal and the received RSSI 1 value to the first CPU 17. The first CPU 17 calculates the value of a second RSSI 2 and may send the calculated RSSI 2 value to the service antenna unit 30. Accordingly, both the donor antenna unit 10 and the service antenna unit 30 may be aware of both the RSSI 1 value and the RSSI 2 value. The second CPU 37 controls the intensity of a signal attributable to a loss of the line of the coaxial cable by controlling the second attenuator 42 in downlink and controlling the third attenuator 43 in uplink with reference to the RSSI 1 value.

In this case, the first CPU 17 compares the RSSI 2 value with an initial RSSI value and determines whether the coaxial cable 50 and the wireless communication network repeater 3 are normal or not based on a result of the comparison. If the coaxial cable 50 is erroneously connected between the donor antenna unit 10 and the service antenna unit 30 or the system 3 is abnormal, the first CPU 17 generates the alarm and may send an alarm message to a higher system, if necessary. The initial RSSI value may be initially set and stored once or may be periodically or aperiodically updated depending on the situation of the wireless communication network repeater 3. Furthermore, in order to check whether abnormality is present, the first CPU 17 may refer to the RSSI 1 value.

The RSSI 1 value and the RSSI 2 value may be stored in flash memory (not illustrated) and then referred by the first CPU 17 or the second CPU 37, if necessary. The RSSI 1 value and the RSSI 2 value may be different depending on the installation length and/or installation type of a cable.

In order to calculate an accurate RSSI value, the mean value of the RSSI 1 value and the RSSI 2 value may be calculated. In this case, the RSSI 1 value or the RSSI mean value is called a measured RSSI value. The second CPU 37 compares the measured RSSI value with a preset RSSI value. The second CPU 37 may control the intensity of a signal by increasing the amount of attenuation of the second attenuator 42 if, as a result of the comparison, the measured RSSI value is found to be greater than the preset RSSI value and by decreasing the amount of attenuation of the second attenuator 42 if, as a result of the comparison, the measured RSSI value is found to be not greater than the preset RSSI value. The RSSI mean value may be used as a measured RSSI value in both uplink and downlink.

Furthermore, upon uplink, the second CPU 37 controls the amount of attenuation of the third attenuator 43 with reference to the RSSI 2 value or the RSSI mean value. That is, assuming that the RSSI 2 value or the RSSI mean value is a measured RSSI value, the second CPU 37 compares the measured RSSI value with a preset RSSI value. The second CPU 37 may control the intensity of a signal by increasing the amount of attenuation of the third attenuator 43 if, as a result of the comparison, the measured RSSI value is found to be greater than the preset RSSI value and by decreasing the amount of attenuation of the third attenuator 43 if, as a result of the comparison, the measured RSSI value is found to be not greater than the preset RSSI value.

Such RSSI measurement is performed in order to optimize the intensity of a signal when it is necessary to compensate for the intensity of the signal due to a change in the length of the coaxial cable 50 depending on an installation place. In some embodiments, such RSSI measurement may be frequently performed in order to compensate for the intensity of a signal depending on a change of a communication environment, if necessary.

Such control of the third attenuator 42 and the fourth attenuator 43 based on the RSSI values are applied to a TDD method. In the case of an FDD method, a measured RSSI value may be calculated by averaging the RSSI 1 value and the RSSI 2 value because a downlink frequency is different from an uplink frequency. In this case, the second CPU 37 refers to the RSSI 2 value in order to control the second attenuator 42 upon downlink and to control the third attenuator 43 upon uplink.

(Function and Configuration of Band Selection Filter)

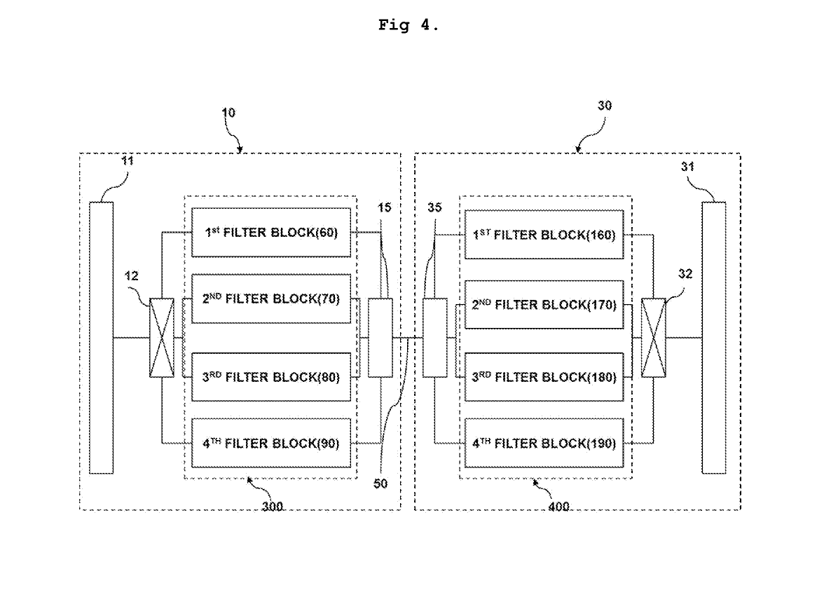

FIG. 4 is an example in which the band selection filter of the wireless communication network repeater in accordance with an embodiment of the present invention is used and is a block diagram illustrating the configuration of the band selection filter of the wireless communication network repeater including four blocks.

FIG. 4 illustrates minimum elements for describing the band selection filter in accordance with an embodiment of the present invention, and reference may be made to additional elements within the technical spirit of the present invention.

Upon downlink, the donor antenna 11 receives an RF signal from the base station 1. The RF signal received by the donor antenna 11 is transferred to the first duplexer 12 and distributed to any one of the first filter block 60, the second filter block 70, the third filter block 80, and the fourth filter block 90 of a first band selection filter 300. The RF signal that has passed through any one of the first to the fourth filter blocks is transmitted to the service antenna unit 30 through the first muxer 15. In this case, the first filter block 60, the second filter block 70, the third filter block 80, and the fourth filter block 90 operate as bandpass filter blocks having different frequency bands, if necessary. For example, if frequency bands range from 1850 MHz to 1915 MHz, filter blocks may be allocated to the respective frequencies. The present invention is not limited to such frequency bands, and the frequency bands may be changed, if necessary.

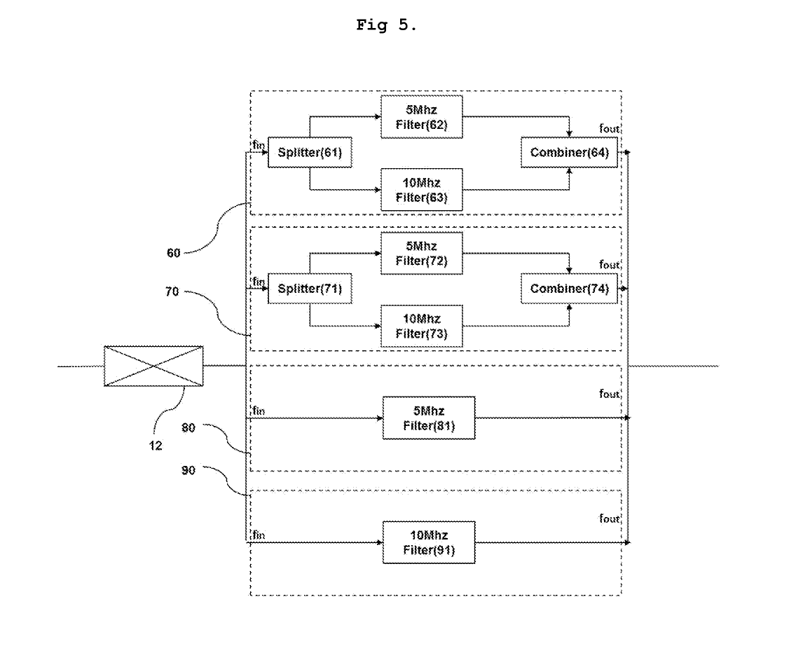

In this case, as illustrated in FIG. 5, the first filter block 60 operates as a 5 MHz, 10 MHz, and 15 MHz bandpass filter using a splitter 61, a 5 MHz filter 62, a 10 MHz filter 63, and a combiner 64. The second filter block 70 operates as a 5 MHz and 10 MHz bandpass filter using a splitter 71, a 5 MHz filter 72, a 10 MHz filter 73, and a combiner 74. The third filter block 80 operates as a 5 MHz bandpass filter using a 5 MHz filter 81. Furthermore, the fourth filter block 90 operates as a 10 MHz bandpass filter using a 10 MHz filter 91.

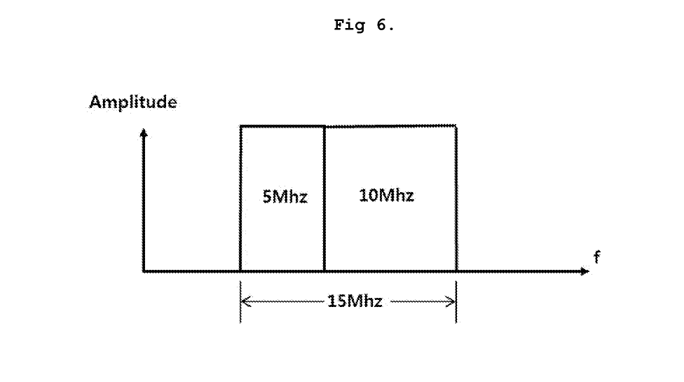

As illustrated in FIG. 6, if a signal is transmitted from the splitter 61 to the 5 MHz filter 62, the first filter block 60 operates as the 5 MHz bandpass filter. If a signal is transmitted from the splitter 61 to the 10 MHz filter 63, the first filter block 60 operates as the 10 MHz bandpass filter. If a signal is transmitted from the splitter 61 to the 5 MHz filter 62 and the 10 MHz filter 63, the first filter block 60 operates as the 15 MHz bandpass filter.

Upon uplink, the second band selection filter 400 of the service antenna unit 30 has the same configuration and operation as the first band selection filter 300 of the donor antenna unit 10, and thus a detailed description thereof is omitted.

In accordance with the aforementioned embodiment of the present invention, the band selection filter 300, 400 has been illustrated as being placed outside the duplexer 12, 32, but the band selection filter 300, 400 may be disposed within the duplexer 12, 32.

(Embodiment in which Omni Antenna is Used)

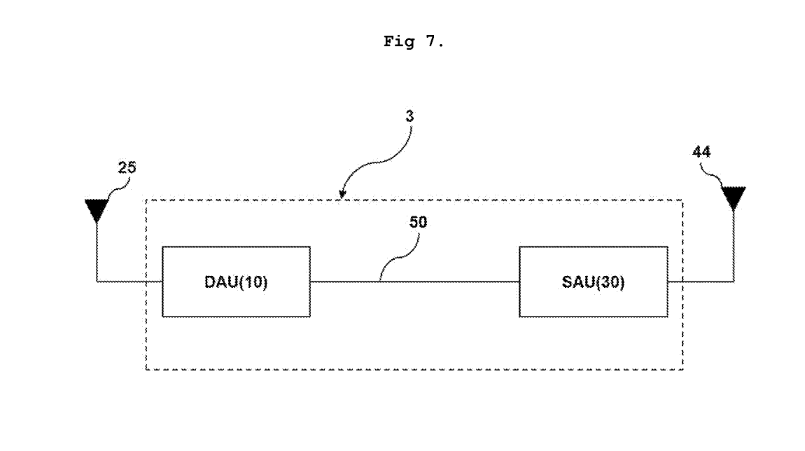

FIG. 7 is a first embodiment of the wireless communication network repeater in accordance with an embodiment of the present invention and is a block diagram illustrating a wireless communication network repeater including omni antennas.

The wireless communication network repeater 3 used to improve quality of a wireless communication network between the base station 1 and the wireless communication device 2 includes the donor antenna unit 10 configured to exchanges RF signals with the base station 1 and the service antenna unit configured to exchange RF signals with the wireless communication device 2. The donor antenna unit 10 includes the embedded donor antenna 11, and the service antenna unit 30 includes the embedded service antenna 31.

In a communication shadow area in which a wireless communication signal is weak, it may not be enough to send and receive signals using only an embedded antenna. In order to solve such a problem, a donor omni antenna 25 and a service omni antenna 44 may be installed outside the donor antenna unit 10 and the service antenna unit 30. In this case, the donor omni antenna 25 may receive an RF signal from the base station 1 at a reception rate higher than that of the embedded donor antenna 11.

The RF signal received through the donor omni antenna 25 is transferred to the coaxial cable 50 through the donor antenna unit 10 and is transmitted to the service antenna unit 30 through the coaxial cable 50. The transmitted RF signal is transferred to the service omni antenna 44 connected to the service antenna unit 30. The service omni antenna 44 sends the RF signal to the wireless communication device 2 and receives an RF signal from the wireless communication device 2.

When the wireless communication device 2 sends an RF signal, the service omni antenna 44 connected to the service antenna unit 30 receives the RF signal from the wireless communication device 2 and sends the received RF signal to the service antenna unit 30. The service antenna unit 30 sends the received RF signal to the donor antenna unit 10 through the coaxial cable 50. The donor antenna unit 10 sends the received RF signal to the base station 1 through the donor omni antenna 25 connected to the donor antenna unit 10.

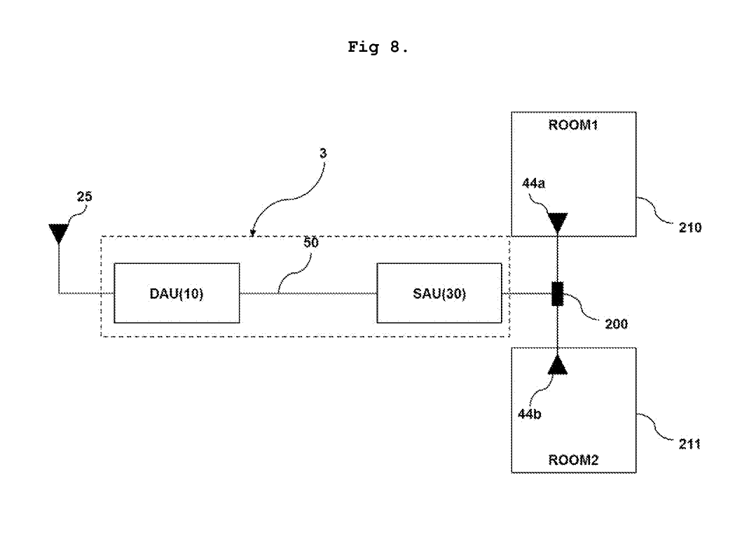

FIG. 8 is a second embodiment of the wireless communication network repeater in accordance with an embodiment of the present invention and is a diagram illustrating that a wireless communication signal is supplied to two rooms spaced apart from each other using the wireless communication network repeater.

The donor omni antenna 25 receives an RF signal from the base station 1. Service omni antennas 44a and 44b sends received RF signals to service areas through the donor antenna unit 10, the coaxial cable 50, and the service antenna unit 30.

In this case, as illustrated in FIG. 8, a splitter 200 (i.e., a two-way divider) splits the RF signal from the service antenna unit 30 into 2 ways. The split RF signals are finally transmitted to the service areas through the respective omni antennas 44a and 44b. In order to solve a service shadow area, the first omni antenna 44a may send the RF signal to a room 1 210, and the second omni antenna 44b may send the RF signal to a room 2 211.

If the wireless communication device 2 of a user is placed in the room 1 210 or the room 2 211, an RF signal transmitted by the wireless communication device 2 is transmitted to the service antenna unit 30 through the service omni antenna 44a of the room 1 210 or the service omni antenna 44b of the room 2 and the splitter 200. Thereafter, the RF signal is transmitted to the donor antenna unit 10 through the coaxial cable 50. The donor omni antenna 25 receives the RF signal from the donor antenna unit 10 and sends the received RF signal to the base station 1.

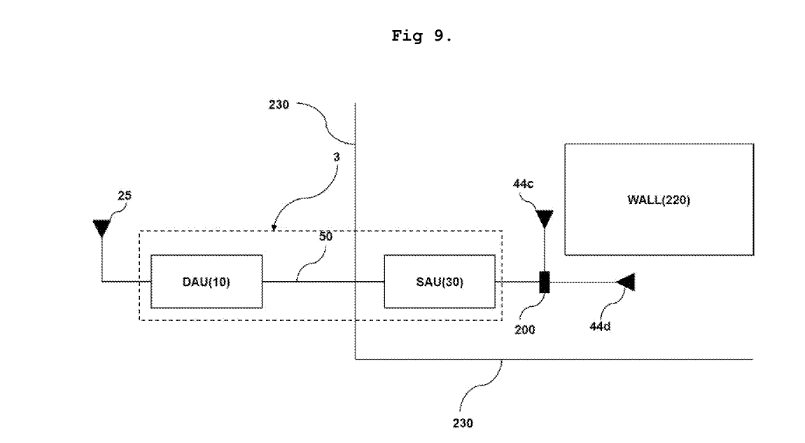

FIG. 9 is a third embodiment of the wireless communication network repeater in accordance with an embodiment of the present invention and is a diagram illustrating that a wireless communication signal is supplied to the inside of a room including an obstacle using the wireless communication network repeater.

An obstacle, such as a pillar or a great wall, is present at the center of a hall or room including a large space in which many people may be accommodated. Accordingly, the transfer of a wireless communication signal may be hindered. As a result, there may be a communication shadow area in which a communication signal is very weak.

In this case, if a service omni antenna 44 is installed according to the third embodiment, such as that illustrated in FIG. 9, a communication shadow area can be reduced and a wireless communication signal of high reliability can be supplied.

As illustrated in FIG. 9, the third embodiment corresponds to a case where a building wall 230 is present and a wall 220 is present in a large hall compared to the second embodiment. If the wall 220 is present in the large hall, a service shadow area may occur. Accordingly, in the third embodiment, such a service shadow area can be solved by installing service omni antennas 44c and 44d in respective directions (e.g., the north and the south) via the splitter 200.

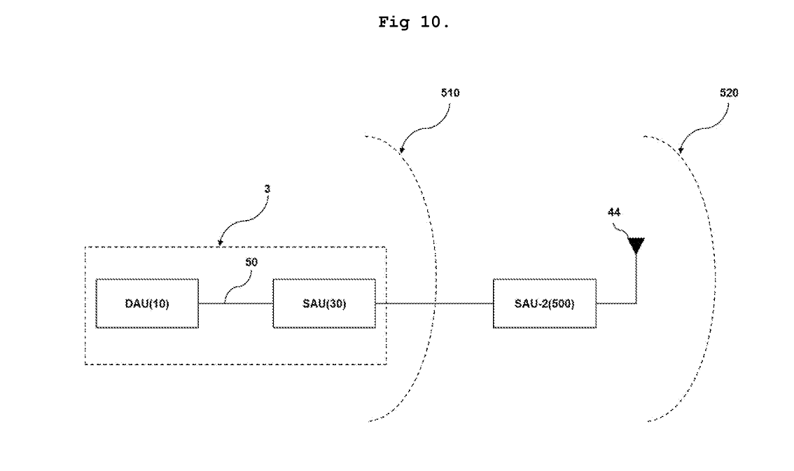

FIG. 10 is a fourth embodiment of wireless communication network repeater in accordance with an embodiment of the present invention and is a diagram illustrating that a wireless communication signal is supplied using an additional service antenna unit.

A phenomenon in which a shadow area occurs may be generated although the service omni antenna 44 has been installed outside the wireless communication network repeater 3 as illustrated in FIGS. 8 and 9.

In this case, the service area of the wireless communication network repeater 3 may be extended by installing an additional service antenna unit-2 500 according to the fourth embodiment, such as that illustrated in FIG. 10. Accordingly, a communication shadow area can be reduced, and a wireless communication signal of high reliability can be supplied.

As illustrated in FIG. 10 the fourth embodiment corresponds to a case where a wireless communication signal is supplied to a shadow area 520 out of the service area 510 of the wireless communication network repeater 3. In this case, the service antenna unit-2 500 is added and connected to the service antenna unit 3 of the wireless communication network repeater 3. The service antenna unit-2 500 receives an RF signal and DC power from the service antenna unit 30. The received DC power is used for the service antenna unit-2 500 to operate, and the received RF signal is transmitted to the shadow area 520 through a service omni antenna 44 that may be installed inside and outside the service antenna unit-2 500. In this case, the service omni antenna 44 sends and receives RF signals to and from the wireless communication device 2.

Although some embodiments of the present invention have been described, the present invention is limited to the embodiments. Those skilled in the art will appreciate that various modifications, additions and substitutions are possible, without departing from the scope and spirit of the invention as disclosed in the accompanying claims.

What is claimed is:

1. A donor antenna unit, comprising:
a donor antenna configured to receive an external RF signal;
a down-converter unit configured to convert the RF signal into an IF signal;
an up-converter unit configured to receive an external IF signal and convert the received IF signal into an RF signal;
a signal generation unit configured to generate a reference synchronization signal or receive an external reference synchronization signal, generate a local signal based on the reference synchronization signal, and output the local signal to the down-converter unit and the up-converter unit; and
a compensation signal generation unit configured to generate a compensation signal for compensating for an intensity of a signal according to a transmission length of a cable.

2. The donor antenna unit of claim 1, further comprising a signal size control unit configured to control a size of the RF signal or IF signal depending on an intensity of the signal.

3. The donor antenna unit of claim 2, wherein the signal size control unit is configured to comprise an attenuator.

4. The donor antenna unit of claim 1, wherein:
the RF signal received from the donor antenna is amplified by a low noise amplifier and transmitted to the down-converter unit, and
the RF signal converted by the up-converter unit is amplified by an RF amplifier and transmitted.

5. The donor antenna unit of claim 1, wherein:
the cable comprises a coaxial cable, and
DC power is supplied by a service antenna unit through the coaxial cable.

6. The donor antenna unit of claim 1, wherein:
the donor antenna comprises an omni antenna, and
the donor antenna is embedded in the donor antenna unit or provided outside the donor antenna unit in order to solve a service shadow area.

7. The donor antenna unit of claim 1, further comprising a bandpass filter block, wherein the bandpass filter block is configured to comprise:
a first bandpass filter block configured to comprise a splitter and a combiner and to form at least any one of filter bands of 5 MHz, 10 MHz, and 15 MHz,
a second bandpass filter block configured to comprise a bandpass filter of 5 MHz, and
a third bandpass filter block configured to comprise a bandpass filter of 10 MHz.

8. The donor antenna unit of claim 1, wherein:
the compensation signal generation unit generates an FSK signal, and
the FSK signal is transmitted to a service antenna unit through the cable.

9. A service antenna unit, comprising:
a service antenna configured to receive an external RF signal;
a down-converter unit configured to convert the RF signal into an IF signal;
an up-converter unit configured to receive an external IF signal and convert the received IF signal into an RF signal;
a signal generation unit configured to generate a reference synchronization signal or receive an external reference synchronization signal, generate a local signal based on the reference synchronization signal, and output the local signal to the down-converter unit and the up-converter unit; and
a signal intensity compensation unit configured to receive an external compensation signal and compensate for an intensity of a signal according to a transmission length of a cable.

10. The service antenna unit of claim 9, wherein:
the RF signal received from the service antenna is amplified by a low noise amplifier and transmitted to the down-converter unit, and
the RF signal converted by the up-converter unit is amplified by an RF amplifier and transmitted.

11. The service antenna unit of claim 9, wherein:
the cable comprises a coaxial cable, and
DC power is supplied to a donor antenna unit through the coaxial cable.

12. The service antenna unit of claim 9, wherein:
the service antenna comprises an omni antenna, and
the service antenna is embedded in the service antenna unit or provided outside the service antenna unit in order to solve a service shadow area.

13. The service antenna unit of claim 12, wherein a plurality of the service antennas is provided if the service antenna is provided outside the service antenna unit.

14. The service antenna unit of claim 9, further comprising a bandpass filter block, wherein the bandpass filter block is configured to comprise:
a first bandpass filter block configured to comprise a splitter and a combiner and to form at least any one of filter bands of 5 MHz, 10 MHz, and 15 MHz,
a second bandpass filter block configured to comprise a bandpass filter of 5 MHz, and
a third bandpass filter block configured to comprise a bandpass filter of 10 MHz.

15. The service antenna unit of claim 9, wherein:
the compensation signal comprises an FSK signal transmitted by a donor antenna unit, and
the signal intensity compensation unit calculates an RSSI value using the FSK signal and compensates for the intensity of a signal by controlling an attenuator based on the RSSI value.

16. The service antenna unit of claim 9, further comprising an FSK signal generation unit configured to generate an FSK signal and send the FSK signal to a donor antenna unit through the cable.

17. A wireless communication network repeater, comprising:
a donor antenna unit configured to receive an RF signal from a base station or a repeater, convert the RF signal into an IF signal, and generate a compensation signal for compensating for an intensity of a signal according to a transmission length of a cable;
a service antenna unit configured to receive an RF signal from a terminal, convert the received RF signal into an IF signal, receive the compensation signal, and compensate for an intensity of a signal according to the transmission length of the cable; and
the cable configured to send signals between the donor antenna unit and the service antenna unit and send at least any one of the IF signal and the compensation signal.

18. The wireless communication network repeater of claim 17, wherein:
at least any one of the donor antenna unit and the service antenna unit generates a reference synchronization signal and sends the reference synchronization signal to a counterpart so that the donor antenna unit and the service antenna unit are synchronized with each other,
the cable comprises a coaxial cable, and
the coaxial cable transfers DC voltage generated by the service antenna unit to the donor antenna unit and transfers the IF signal, the compensation signal, the reference synchronization signal, and the DC voltage.

19. The wireless communication network repeater of claim 17, wherein:
the service antenna unit generates an FSK signal and sends the FSK signal to the donor antenna unit, and
the donor antenna unit calculates an RSSI value using the FSK signal and determines whether the cable is normal or not.

20. The wireless communication network repeater of claim 17, wherein:
the compensation signal comprises an FSK signal, and
the service antenna unit calculates an RSSI value using the FSK signal and controls at least any one of a downlink attenuator and an uplink attenuator based on the RSSI value.
